(19) United States
(12) Patent Application Publication
(10) Pub. No.: US 2016/0365195 A1
(43) Pub. Date: Dec. 15, 2016

(54) METHOD FOR MANUFACTURING VOICE COIL

(71) Applicant: STS Semiconductor & Telecommunications Co., Ltd., Chungcheongnam-do (KR)

(72) Inventors: Jai Kyoung CHOI, Busan (KR); Eun Dong KIM, Seoul (KR); Hyun Hak JUNG, Chungcheongnam-do (KR); Hyeong Min KIM, Gangwon-do (KR); Su Kyung LIM, Gyeongsangbuk-do (KR)

(21) Appl. No.: 14/795,226

(22) Filed: Jul. 9, 2015

(30) Foreign Application Priority Data
Jun. 9, 2015 (KR) 10-2015-0081101

(51) Int. Cl. H01F 41/04

(52) U.S. Cl. CPC H01F 41/04

(57) ABSTRACT

Provided is a method for manufacturing a voice coil, and more particularly, to a voice coil manufacturing method for forming a coil pattern on a wafer level package. The method for manufacturing a voice coil includes forming a first passivation layer on an upper surface of a wafer, forming a first coil directly on the first passivation layer, forming a second passivation layer on the first passivation layer and on an upper surface of the first coil, forming a third passivation layer on an upper surface of the second passivation layer, forming a second coil directly on the third passivation layer, and forming an external connection terminal on a portion of the second coil.

### CROSS-REFERENCE TO RELATED APPLICATIONS

This application claims priority under 35 U.S.C. §119 to Korean Patent Application No. 10-2015-0081101, filed on Jun. 9, 2015, the disclosure of which is incorporated herein by reference in its entirety.

### TECHNICAL FIELD

The present invention relates to a method for manufacturing a voice coil, and more particularly, to a voice coil manufacturing method for forming a coil pattern on a wafer level package.

### BACKGROUND

Camera modules are classified as a voice coil motor (VCM) type module, an encoder type module, and a piezo type module, and in terms of cost effectiveness, the VCM type module is commonly used. In the VCM type module, magnetic flux density of a magnetic field of a permanent magnet and a force proportional to a current flowing in a coil are generated in a right angle direction with respect to the magnetic field and the current to move a lens to an optimal position.

When a VCM moves up and down along a cam structure according to rotation of an actuator, a lens is released from a focused state due to lens tilt, backlash, an external impact, and wobbling. Thus, in order to stably operate the lens without wobbling when the lens moves up and down, a spring having preload fitting an autofocusing (AF) module is required. Using the spring, the lens is precisely guided and supported, and an impulsive pulse generated when a cellular phone is in use may be buffered to protect the lens.

Here, however, when the spring is permanently deformed due to an impact, or the like, a driving tilt occurs to cause driving release in a diagonal direction, rather than in a vertical direction, during a vertical movement, generating horizontal or vertical variations of an image to make it difficult to obtain a precise image.

Also, a coil applied to the VCM is dependent upon maximum magnetic flux density, and thus, when the coil exceeds the maximum magnetic flux density, the coil is self-saturated to lose magnetic force, becoming a simple electric wire. Thus, when high magnetic flux density is required, a volume as large as not causing the coil to be self-saturated is required.

A winding coil applied to an optic image stabilizer (OIS) actuator, or the like, used as an OIS has a large thickness and limitations in a manufacturing scheme, having difficulty in realizing a fine line width. Also, as a result, efficiency of integration is degraded. However, implementation of the corresponding winding coil as a device has advantages in that a volume of a camera module may be reduced, and in particular, an influence on permanent deformation of a spring in a spring type VCM can be minimized, increasing reliability.

Thus, a winding coil applied to an actuator or the like has a large thickness and a fine line width needs to be implemented, but there are limitations with the related art redistributed layer (RDL) type winding coil manufacturing method.

### SUMMARY

Accordingly, the present invention provides a voice coil manufacturing method for forming a coil pattern on a wafer level package.

The present invention also provides a voice coil manufacturing method for forming a coil pattern with a fine line width.

The present invention also provides a voice coil manufacturing method for preventing a void, which may be generated when a passivation layer is formed on a coil pattern, by performing a plating process for a coil pattern directly on the passivation layer.

The object of the present invention is not limited to the aforesaid, but other objects not described herein will be clearly understood by those skilled in the art from descriptions below.

In one general aspect, a method for manufacturing a voice coil includes: forming a first passivation layer on an upper surface of a wafer; forming a first coil directly on the first passivation layer; forming a second passivation layer on the first passivation layer and on an upper surface of the first coil; forming a third passivation layer on an upper surface of the second passivation layer; forming a second coil directly on the third passivation layer; and forming an external connection terminal on a portion of the second coil.

The forming of a first coil may include: forming a first coil pattern on the first passivation layer; forming a first seed metal layer on a surface of the first coil pattern and on an upper surface of the first passivation layer; selectively forming a first photoresist layer only on an upper surface of the first seed metal layer formed on the upper surface of the first passivation layer; and plating a conductive metal on the first coil pattern with the first seed metal layer formed thereon, and removing the first seed metal layer formed on the first photoresist layer and on the upper surface of the first passivation layer.

The forming of a second passivation layer may include: forming an opening such that a partial winding of the first coil is exposed, wherein the exposed partial winding of the first coil may be connected to the second coil, whereby the first coil and the second coil are electrically connected.

The forming of a second coil may include: forming a second coil pattern on the third passivation layer; forming a second seed metal layer on a surface of the second coil pattern and on an upper surface of the third passivation layer; selectively forming a second photoresist layer only on an upper surface of the second seed metal layer formed on the upper surface of the third passivation layer; and plating a conductive metal on the second coil pattern with the second seed metal layer formed thereon, and removing the second seed metal layer formed on the second photoresist layer and on the upper surface of the third passivation layer.

The forming of an external connection terminal may include: forming a fourth passivation layer including an opening exposing a portion of the second coil; forming an under bump metallization (UBM) layer on the opening formed in the fourth passivation layer using a sputtering method; forming a photoresist layer in the vicinity of the UBM layer using a photolithography process and applying a soldering metal to a recess formed by the UBM layer and the photoresist layer; and removing the photoresist layer and the UBM layer.

A thickness of a winding of each of the first coil and the second coil may range from 10 μm to 200 μm.

A width of the winding of each of the first coil and the second coil may be 20 μm or less.

Other features and aspects will be apparent from the following detailed description, the drawings, and the claims.

### BRIEF DESCRIPTION OF THE DRAWINGS

FIG. 1 is a plan view illustrating a voice coil according to an embodiment of the present invention.

FIG. 2 is a cross-sectional view taken along line A-A′ of FIG. 1.

FIGS. 3A through 3L are cross-sectional views taken along line A-A′ or B-B′ of FIG. 1, illustrating a process of a method for manufacturing a voice coil according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

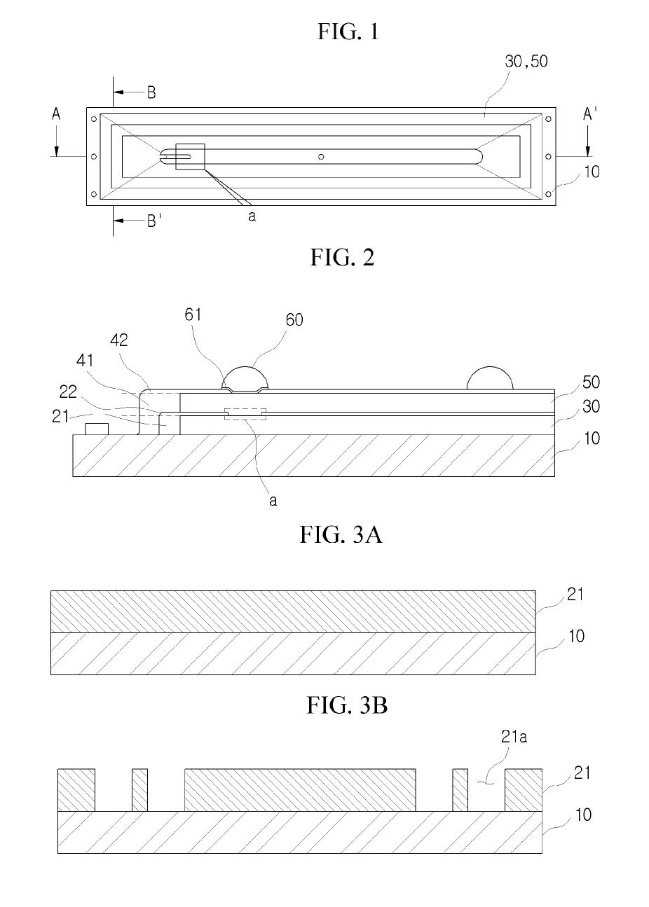

FIG. 1 is a plan view illustrating a voice coil according to an embodiment of the present invention, and FIG. 2 is a cross-sectional view taken along line A-A′ of FIG. 1.

The present invention relates to a structure of a voice coil manufactured at a wafer level and a manufacturing method thereof.

As illustrated in FIGS. 1 and 2, the voice coil according to an embodiment of the present invention includes a wafer 10, a first passivation layer 21, a second passivation layer 22, a first coil 30, a third passivation layer 41, a fourth passivation layer 42, a second coil 50, and an external connection terminal 60.

The first passivation layer 21 is formed on the wafer 10 and provides a coil pattern for disposing the first coil 30 on the wafer 10. The first coil 30 may be disposed according to the coil pattern formed in the first passivation layer 21 and may be formed through a general plating process. The second passivation layer 22 is formed on the first passivation layer 21 and on the first coil 30 to prevent the first coil exposed in the air from being oxidized. Here, a portion of the second passivation layer 22 is patterned to expose a portion (a) of the first coil 30. The exposed portion (a) of the first coil 30 is connected to the second coil 50 (to be described hereinafter), whereby the first coil 30 and the second coil 50 may be electrically connected.

The third passivation layer 41 is formed on second passivation layer 22 and provides a coil pattern for stacking the second coil 50 on the first coil 30. The second coil 50 may be disposed according to the coil pattern formed on the third passivation layer 41, and may be formed through a general plating process. The fourth passivation layer 42 is formed on the third passivation layer 41 and on the second coil 50 to prevent the second coil 50 exposed in the air from being oxidized. Here, a region of the fourth passivation layer 42 is patterned to expose a portion of the second coil 50. The exposed portion of the second coil 50 is electrically connected to the external connection terminal 60, and here, an under-bump metallization (UBM) layer is formed between the portion of the second coil 50 and the external connection terminal 60 to optimize electrical contact between the external connection terminal 60 and the second coil 50.

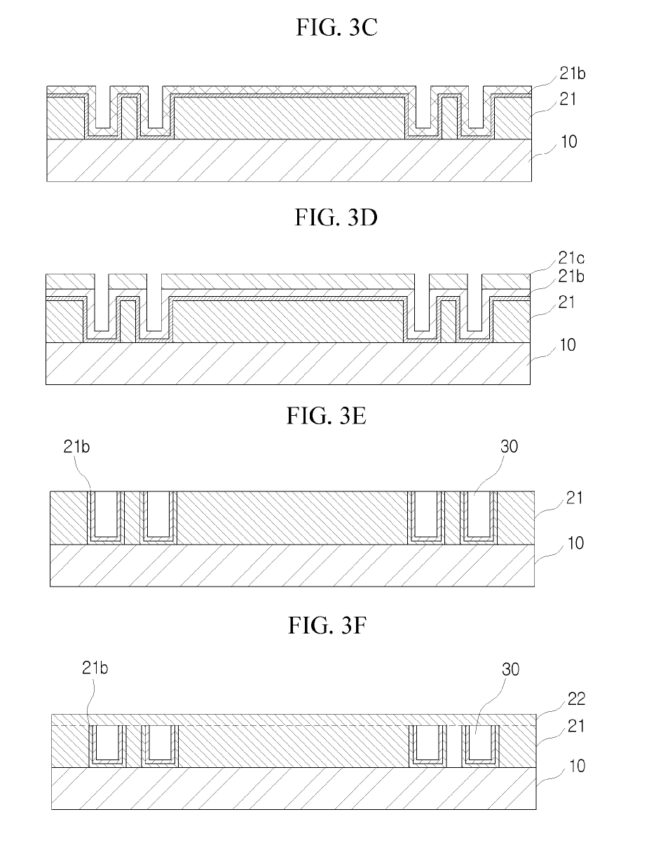

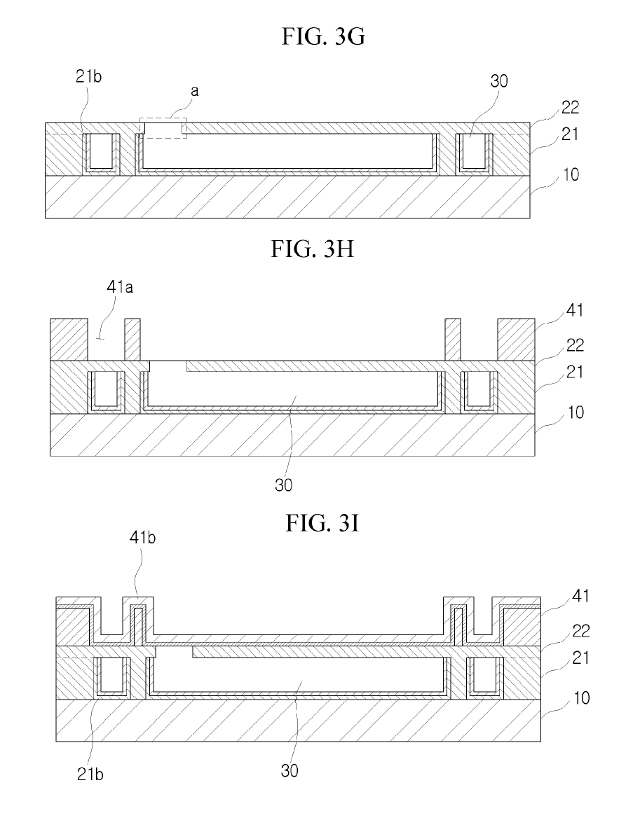

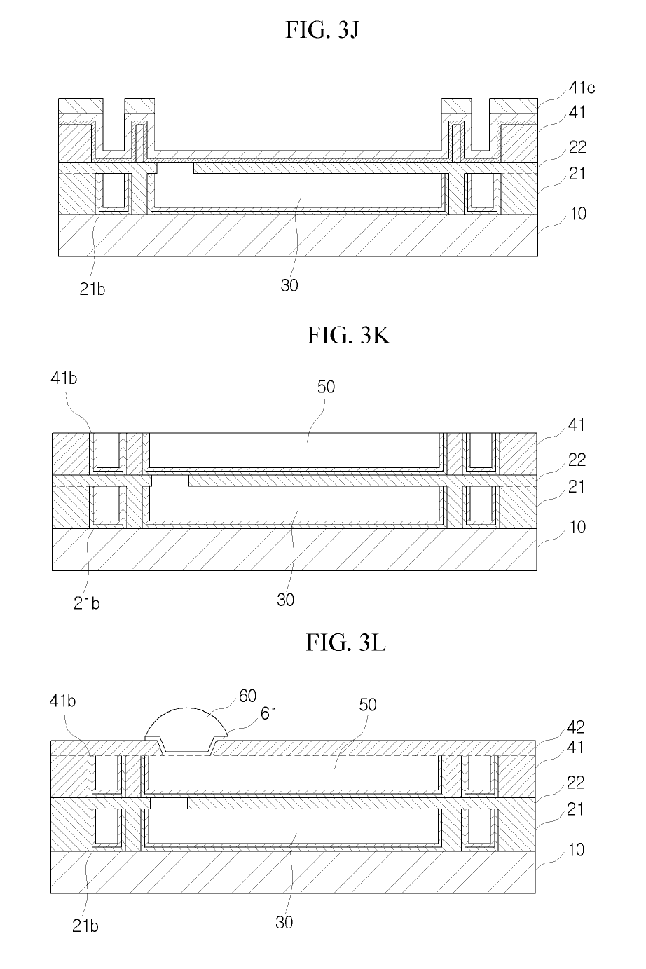

Hereinafter, the foregoing voice coil will be described with reference to FIGS. 3A through 3K. FIGS. 3A through 3F are cross-sectional views taken along line B-B′ of FIG. 1, illustrating a process of a method for manufacturing a voice coil according to an embodiment of the present invention, and FIGS. 3G through 3L are cross-sectional views taken along line A-A′ of FIG. 1, illustrating a process of a method for manufacturing a voice coil according to an embodiment of the present invention.

For the purposes of description, it is illustrated that only two coil windings are formed in FIGS. 3A through 3F, but this is merely illustrative and the present invention is not limited thereto.

First, as illustrated in FIG. 3A, the first passivation layer 21 is formed on the wafer 10. The first passivation layer 21 may be a multilayer including various insulating films formed of polyimide (PI), polybenzoxazole (PBO), EMC, resins, or phenol+rubber type.

Next, as illustrated in FIG. 3B, a coil pattern 21a for disposing the first coil 30 is formed on the first passivation layer 21. The coil pattern 21a may be formed through a general photo process.

Thereafter, as illustrated in FIG. 3C, a first seed metal layer 21b is formed on a surface of the coil pattern 21a and on an upper surface of the first passivation layer 21. The first seed metal layer 21b is not particularly limited and may be formed of any metal as long as the metal is easily electrically conducted and does not generate an intermetallic compound. Such a metal may be titanium (Ti) or an alloy thereof capable of suppressing intermetallic spreading. For example, the first seed metal layer 21b may be formed of titanium alone or may be formed of an alloy of titanium/copper or titanium/tungsten/copper. The first seed metal layer 21b may be formed through a method such as sputtering or chemical vapor deposition (CVD) but the present invention is not limited thereto.

Thereafter, as illustrated in FIG. 3D, a first photoresist layer 21c is selectively formed only on an upper surface of the first seed metal layer 21b formed on the first passivation layer 21. The first photoresist layer 21c may be selectively formed to be intaglioed on the first seed metal layer 21b using a photolithography process using a photomask. In detail, the first photoresist layer 21c may be formed through a process of forming a photoresist layer and a process of aligning the photomask on an upper surface of the photoresist layer and irradiating light thereto to remove a portion of the photoresist layer corresponding to a region in which a coil winding is to be formed. Here, the photomask has a pattern so that light is prevented from being irradiated to the photoresist layer therebelow. The photoresist may be a photosensitive resin, i.e., a positive photoresist in which polymers are solubilized only in a portion to which light is irradiated and resist disappears. For example, polymethyl methacrylate, napthoquinonediazide, or polybutene-1-sulfone may be used as the positive photoresist.

On the other hand, a negative photoresist may also be used, and in this case, a photomask may be manufactured to have a pattern opposite to that of the positive photomask. In the negative photoresist, only a portion to which light is not irradiated during an exposure process is solubilized and removed during a developing process. For example, the positive photomask includes a dark field coated with a chromium thin film and a clear pattern with a pattern to which light is irradiated, and the negative photomask includes a dark pattern coated with a chromium thin film and a clear field having an opening to which light is irradiated.

Thereafter, as illustrated in FIG. 3E, a coil winding formed of a metal is plated on the coil pattern 21a formed on the first passivation layer 21, and accordingly, a first coil 30 is formed. The first coil 30 may be formed through a general plating process. For example, a method of immersing the surface with the coil pattern formed thereon in a plating solution may be used. The plating solution is a solution in which metal ions of a coil winding is dissolved, and the plating solution may further include an acid electrolyte selectively. The acid electrolyte may be, for example, sulfuric acid, but the present invention is not limited thereto.

In an embodiment, the first coil 30 may be formed through electroplating, and here, a metal is not plated on the first photoresist layer 21c, an insulator, but selectively plated only on the first seed metal layer 21b. Also, a portion of the first seed metal layer 21b is oxidized to form a metal oxide. The metal oxide is electrically an insulator, and thus, only a portion of the first seed metal layer 21b may be selectively plated to form a desired winding shape. FIG. 3E illustrates a configuration obtained immediately after the plating process and removing of the first photoresist layer 21c and the first seed metal layer 21b are removed, and here, only the exposed portions of the seed metal layer 21b are removed according to removal of the first photoresist layer 21c. Removing of the seed metal layer 21b may be performed through dry etching or wet etching, without being particularly limited to a specific method.

Thereafter, as illustrated in FIG. 3F, a second passivation layer 22 is formed on the first passivation layer 21 and the first coil. The second passivation layer 22 is formed on the first passivation layer 21 and the first coil 30 to prevent the first coil 30 exposed in the air from being oxidized. Here, a portion of the second passivation layer 22 is patterned to expose a portion (a) of the first coil 30. The exposed portion of the first coil 30 is connected to a second coil 50 (to be described hereinafter) such that the first coil and the second coil 50 are electrically connected.

FIG. 3G is a cross-sectional view of FIG. 3F taken along line A-A′ of FIG. 1. Hereinafter, a process of stacking the second coil 50 (to be described hereinafter) on the first coil 30 by taking along the line A-A′ of FIG. 1 will be described with reference to FIGS. 3H through 3L.

First, as illustrated in FIG. 3H, a third passivation layer 41 is formed on the second passivation layer 22. The third passivation layer 41 may be a multilayer including various insulating films formed of polyimide (PI), polybenzoxazole (PBO), EMC, resins, or phenol+rubber type. A coil pattern 41a for disposing the second coil 50 is formed on the third passivation layer 41, and here, the coil pattern 41a may be formed using a general photo process. FIG. 3G illustrates a result of forming the coil pattern 41a on the third passivation layer 41.

Thereafter, as illustrated in FIG. 31, a second seed metal layer 41b is formed on a surface of the coil pattern 41a and on an upper surface of the third passivation layer 41. The second seed metal layer 41b is not particularly limited and may be formed of any metal as long as the metal is easily electrically conducted and does not generate an intermetallic compound. Such a metal may be titanium (Ti) or an alloy thereof capable of suppressing intermetallic spreading. For example, the second seed metal layer 41b may be formed of titanium alone or may be formed of an alloy of titanium/copper or titanium/tungsten/copper. The second seed metal layer 41b may be formed through a method such as sputtering or chemical vapor deposition (CVD) but the present invention is not limited thereto.

Thereafter, as illustrated in FIG. 3J, a second photoresist layer 41c is selectively formed only on the second seed metal layer 41b formed on the third passivation layer 41. The second photoresist layer 41c may be selectively formed to be intaglioed on the second seed metal layer 41b using a photolithography process using a photomask. In detail, the second photoresist layer 41b may be formed through a process of forming a photoresist layer and a process of aligning the photomask on an upper surface of the photoresist layer and irradiating light thereto to remove a portion of the photoresist layer corresponding to a region in which a coil winding is to be formed. Here, the photomask has a pattern so that light is prevented from being irradiated to the photoresist layer therebelow. The photoresist may be a photosensitive resin, i.e., a positive photoresist in which polymers are solubilized only in a portion to which light is irradiated and resist disappears. For example, polymethyl methacrylate, napthoquinonediazide, or polybutene-1-sulfone may be used as the positive photoresist. On the other hand, a negative photoresist may also be used, and in this case, a photomask may be manufactured to have a pattern opposite to that of the positive photomask. In the negative photoresist, only a portion to which light is not irradiated during an exposure process is solubilized and removed during a developing process. For example, the positive photomask includes a dark field coated with a chromium thin film and a clear pattern with a pattern to which light is irradiated, and the negative photomask includes a dark pattern coated with a chromium thin film and a clear field having an opening to which light is irradiated.

Thereafter, as illustrated in FIG. 3K, a coil winding formed of a metal is plated on the coil pattern 41a formed on the second passivation layer 41, and accordingly, a second coil 50 is formed. The second coil 50 may be formed through a general plating process. For example, a method of immersing the surface with the coil pattern formed thereon in a plating solution may be used. The plating solution is a solution in which metal ions of a coil winding is dissolved, and the plating solution may further include an acid electrolyte selectively. The acid electrolyte may be, for example, sulfuric acid, but the present invention is not limited thereto.

Through such a process, the second coil 50 is stacked on the first coil 30 with the passivation layer interposed therebetween, and a portion of the first coil 30 exposed to the second passivation layer 22 is connected to the second coil 50 such that the first coil 30 and the second coil 50 are electrically connected. In the present disclosure, for the purposes of description, the structure in which two coils are stacked has been described, but this is merely illustrative and the present invention is not limited thereto.

Thereafter, as illustrated in FIG. 3L, a fourth passivation layer 42 including an opening exposing a portion of the second coil 50 is formed on the third passivation layer 41. A UBM layer 61 is formed on the opening formed in the fourth passivation layer 42, and a photo process is performed on the UBM layer 61 in order to determine a portion for plating an external connection terminal 60.

For example, a photoresist layer is formed in the vicinity of the UBM layer 61 using a photolithography process, and a soldering metal is applied to a recess formed by the UBM layer 61 and the photoresist layer to optimize electrical contact between the external connection terminal 60 and the second coil 50. Thereafter, the photoresist layer and the UBM layer are removed to manufacture a voice coil as illustrated in FIG. 3K. Here, the external connection terminal 60 may be a bump and may include gold, silver, copper, tin, or nickel. Also, a general reflow process may be performed to enhance an electrical connection between the second coil 50 and the external connection terminal 60.

As described above, according to the present invention, coils may be formed to be thick, while bridge between the coil windings are prevented from occurring, and a coil pattern may be formed to have a fine line width.

Also, since a plating process for the coil pattern is directly performed on a passivation layer, a void that may be generated when a passivation layer is formed on the coil pattern may be prevented.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for manufacturing a voice coil, the method comprising:
forming a first passivation layer on an upper surface of a wafer;
forming a first coil directly on the first passivation layer;
forming a second passivation layer on the first passivation layer and on an upper surface of the first coil;
forming a third passivation layer on an upper surface of the second passivation layer;
forming a second coil directly on the third passivation layer; and
forming an external connection terminal on a portion of the second coil.

2. The method of claim 1, wherein the forming of a first coil includes:
forming a first coil pattern on the first passivation layer;
forming a first seed metal layer on a surface of the first coil pattern and on an upper surface of the first passivation layer;
selectively forming a first photoresist layer only on an upper surface of the first seed metal layer formed on the upper surface of the first passivation layer; and
plating a conductive metal on the first coil pattern with the first seed metal layer formed thereon, and removing the first seed metal layer formed on the first photoresist layer and on the upper surface of the first passivation layer.

3. The method of claim 1, wherein the forming of a second passivation layer includes forming an opening such that a partial winding of the first coil is exposed, wherein the exposed partial winding of the first coil is connected to the second coil, whereby the first coil and the second coil are electrically connected.

4. The method of claim 1, wherein the forming of a second coil includes:
forming a second coil pattern on the third passivation layer;
forming a second seed metal layer on a surface of the second coil pattern and on an upper surface of the third passivation layer;
selectively forming a second photoresist layer only on an upper surface of the second seed metal layer formed on the upper surface of the third passivation layer; and
plating a conductive metal on the second coil pattern with the second seed metal layer formed thereon, and removing the second seed metal layer formed on the second photoresist layer and on the upper surface of the third passivation layer.

5. The method of claim 1, wherein the forming of an external connection terminal includes:
forming a fourth passivation layer including an opening exposing a portion of the second coil;
forming an under bump metallization (UBM) layer on the opening formed in the fourth passivation layer using a sputtering method;
forming a photoresist layer in the vicinity of the UBM layer using a photolithography process and applying a soldering metal to a recess formed by the UBM layer and the photoresist layer; and
removing the photoresist layer and the UBM layer.

6. The method of claim 1, wherein a thickness of a winding of each of the first coil and the second coil ranges from 10 μm to 200 μm.

7. The method of claim 1, wherein a width of a winding of each of the first coil and the second coil is 20 μm or less.
